(19) United States
(12) Patent Application Publication
(10) Pub. No.: US 2023/0349405 A1
(43) Pub. Date: Nov. 2, 2023

(54) SCREW MEMBER, SCREW MEMBER FASTENING METHOD, AND SCREW MEMBER FASTENING DEVICE

(71) Applicant: HONDA MOTOR CO., LTD., Tokyo (JP)

(72) Inventor: Hideari KAMACHI, Tokyo (JP)

(21) Appl. No.: 18/183,172

(22) Filed: Mar. 14, 2023

(30) Foreign Application Priority Data
Mar. 31, 2022 (CN) 202210346168.2

(51) Int. Cl. F16B 5/02; B23P 19/06; F16B 35/04

(52) U.S. Cl. CPC F16B 5/025; B23P 19/06; F16B 35/041

(57) ABSTRACT

A screw member includes: a shank part that has a circular columnar shape and has a screw thread formed on an outer circumferential surface thereof; a head part provided on one axial end part of the shank part; and a guiding protrusion protruding from the other axial end part of the shank part in a direction in which the other axial end part faces. A tip end part of the guiding protrusion has a long direction and a short direction perpendicular to the long direction.

This application is based on and claims the benefit of priority from Chinese Patent Application No. CN202210346168.2, filed on 31 Mar. 2022, the content of which is incorporated herein by reference.

### BACKGROUND OF THE INVENTION

### Field of the Invention

The present invention is related to a screw member which may be a bolt, a screw member fastening method, and a screw member fastening device.

### Related Art

Conventionally, when a fastening member 100 and a fastening target 101 are to be fastened together by a screw 102 as shown in FIG. 9, if a screw hole 103 in the fastening member 100 is out of alignment with a through hole 104 in the fastening target 101, a tip end part of the screw 102 is at first diagonally inserted into the screw hole 103 via the through hole 104. The screw 102 has no screw thread on the tip end part that has a circular truncated cone shape. Subsequently, as shown in FIG. 10, the screw 102 is brought into an upright position so as to move the fastening target 101 relative to the fastening member 100, thereby correcting the misalignment between the screw hole 103 and the through hole 104. After the correction, the screw 102 is turned on the axis thereof so as to be screwed into the screw hole 103, whereby the fastening member 100 and the fastening target 101 are fastened together by the screw 102. According to this method, at the time of bringing the screw 102 into an upright position, a large force is required.

Japanese Unexamined Patent Application, Publication No. 2001-159412 discloses a bolt to be screwed into a female threaded part such as a nut or the like. The bolt has a head part and a shank part having a male screw thread formed thereon. In a tip end part of the shank part, a screwing-entry correction plane is formed, while a guiding protrusion protrudes from the screwing-entry correction plane. Due to this configuration, when the bolt is to be screwed into a nut while the nut is tilted relative to the bolt, the screwing-entry correction plane acts on the nut, so as to generate a momentum in the direction to eliminate the tilt. As a result, it is possible to screw the bolt into the nut, while the axial center of the bolt and the axial center of the nut are concentric. In this situation, however, because the bolt is screwed into the nut while the nut is tilted relative to the bolt, there is a possibility that the bolt may be screwed into the nut while the tilted state is maintained. This may be a cause of defective fastening at the time of fixation using the bolt.

Patent Document 1: Japanese Unexamined Patent Application, Publication No. 2001-159412

### SUMMARY OF THE INVENTION

It is an object of the present invention to provide a screw member, a screw member fastening method, and a screw member fastening device capable of facilitating fastening without causing defective fastening.

(1) A screw member according to the present invention includes: a shank part having a circular columnar shape and having a screw thread formed on an outer circumferential surface thereof; a head part provided on one axial end part of the shank part; and a guiding protrusion protruding from an other axial end part of the shank part in a direction in which the other axial end part faces. A tip end part of the guiding protrusion has a long direction and a short direction perpendicular to the long direction.

(2) In the screw member according to the present invention described in (1) above, the tip end part of the guiding protrusion may have an oval shape.

(3) In the screw member according to the present invention described in (1) above, the tip end part of the guiding protrusion may have a rhomboidal shape.

(4) A screw member fastening method according to the present invention uses the screw member described in any one of (1) to (3) above for fastening a fastening member having a screw hole into which the screw member is to be screwed and a fastening target having a through hole to be penetrated by the screw member. The screw member fastening method includes: a member placement step of placing the fastening target on the fastening member such that a part of the screw hole overlaps with a part of the through hole; a guiding protrusion insertion step of inserting the guiding protrusion into the screw hole via the through hole in such a manner that the long direction of the tip end part of the guiding protrusion extends along a long direction of an overlap part where the part of the screw hole overlaps with the part of the through hole; a guiding protrusion turning step of turning the screw member on an axis thereof so as to move the fastening target relative to the fastening member, thereby enlarging the overlap part; and a fastening step of screwing the shank part of the screw member into the screw hole via the through hole by turning the screw member on the axis thereof.

(5) A screw member fastening device according to the present invention is for fastening, by using the screw member described in any one of (1) to (3) above, a fastening member having a screw hole into which the screw member is to be screwed and a fastening target having a through hole to be penetrated by the screw member. The screw member fastening device is configured such that: in a state in which the fastening target is placed on the fastening member while a part of the screw hole overlaps with a part of the through hole, the screw member fastening device inserts the guiding protrusion into the screw hole via the through hole in such a manner that the long direction of the tip end part of the guiding protrusion extends along a long direction of an overlap part where the part of the screw hole overlaps with the part of the through hole; the screw member fastening device subsequently turns the screw member on the axis thereof so as to move the fastening target relative to the fastening member, thereby enlarging the overlap part; and the screw member fastening device further turns the screw member on the axis thereof so as to screw the shank part of the screw member into the screw hole via the through hole. The screw member fastening device includes: a mover having a holding part that is configured to hold the screw member, and configured to move the holding part; an imager configured to obtain an image by imaging the screw member held by the holding part and imaging the overlap part; and a controller configured to control the mover on a basis of the image obtained by the imager.

The present invention provides the screw member, the screw member fastening method, and the screw member fastening device capable of facilitating fastening without causing defective fastening.

### BRIEF DESCRIPTION OF THE DRAWINGS

FIG. 1 is a perspective view illustrating a screw member according to a first embodiment of the present invention, as viewed from the bottom;

FIG. 2 is a bottom view illustrating the screw member in FIG. 1;

FIG. 3 is a front view illustrating a state in which the screw member in FIG. 1 is being used, partially shown in cross section;

FIG. 4 is a plan view illustrating a state in which the screw member in FIG. 1 is being used, while a part thereof is omitted;

FIG. 5 is a front view illustrating another state in which the screw member in FIG. 1 is being used, after the screw member has been turned on the axis thereof from the state shown in FIG. 3;

FIG. 6 is a plan view illustrating a state in which the screw member in FIG. 1 is being used while a part thereof is omitted, after the screw member has been turned on the axis thereof from the state shown in FIG. 3;

FIG. 7 is a drawing for explaining a force that is applied when the screw member in FIG. 1 is turned on the axis thereof;

FIG. 8 is a bottom view illustrating a screw member according to a second embodiment of the present invention;

FIG. 9 is a front view illustrating a state in which a conventional screw member is being used;

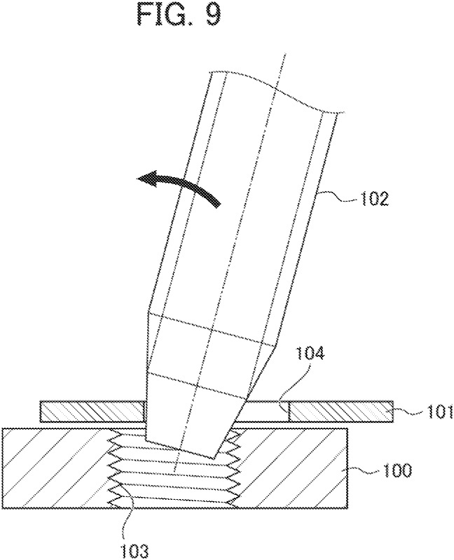

FIG. 10 is a front view illustrating another state in which the conventional screw member is being used, after the screw member is brought into an upright position from the state shown in FIG. 9; and

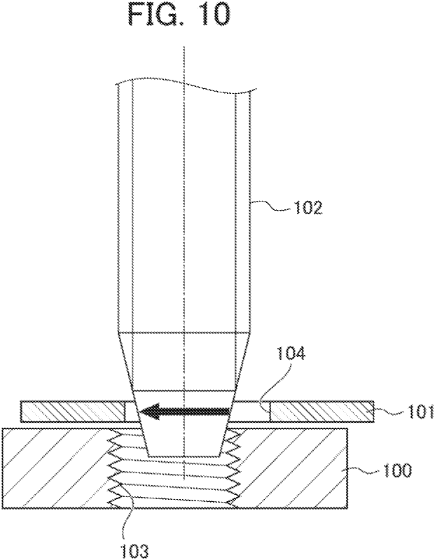

FIG. 11 is a schematic diagram illustrating a configuration of a screw member fastening device according to an embodiment of the present invention.

### DETAILED DESCRIPTION OF THE INVENTION

The following will describe specific embodiments of the present invention in detail, with reference to the drawings.

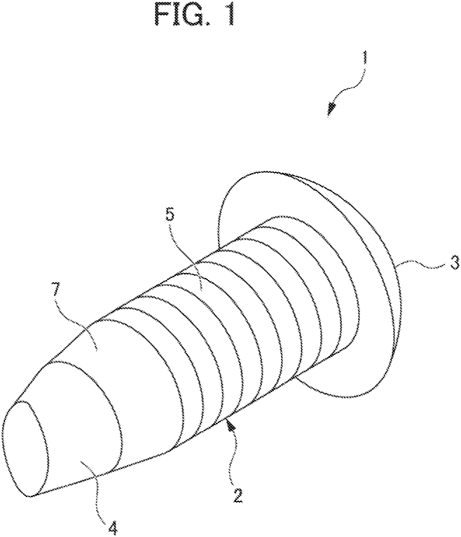

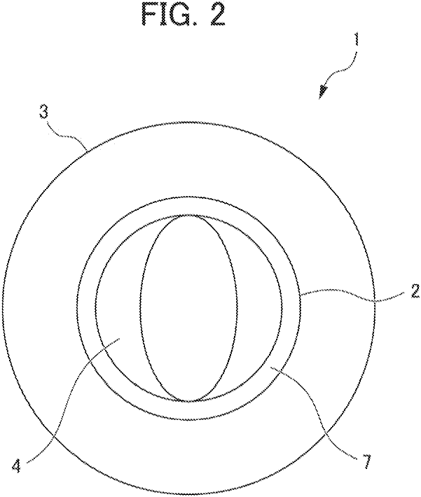

FIG. 1 and FIG. 2 are drawings illustrating a screw member according to a first embodiment of the present invention. FIG. 1 is a perspective view illustrating a state as viewed from the bottom. FIG. 2 is a bottom view. A screw member 1 according to the first embodiment includes a shank part 2, a head part 3, and a guiding protrusion 4. The screw member 1 does not necessarily have to be the screw shown in FIG. 1, but may be a bolt.

The shank part 2 has a circular columnar shape extending in the axial direction. The shank part 2 has a screw thread 5 formed on its outer circumferential surface. The shank part 2 has the head part 3 on its one axial end part. The head part 3 has a groove in which a tool such as a screwdriver may be inserted. The shank part 2 has the guiding protrusion 4 on the other axial end part. The guiding protrusion 4 protrudes from the other axial end part of the shank part 2 in the direction in which the other axial end part faces. The tip end part of the guiding protrusion 4 has a long direction and a short direction perpendicular to the long direction. More specifically, the tip end part of the guiding protrusion 4 has a cross-sectional plane which is perpendicular to the axial direction and which has the long direction and the short direction perpendicular to the long direction. In the first embodiment, the cross-sectional plane 6 of the tip end part of the guiding protrusion 4 is perpendicular to the axial direction and has an oval shape. The length of the cross-sectional plane 6 of the guiding protrusion 4 in the long direction is shorter than the diameter of the shank part 2 having the screw thread 5 formed thereon. In other words, the length of the cross-sectional plane 6 of the guiding protrusion 4 in the long direction is smaller than the outside diameter of the screw member 1.

Further, as shown in FIG. 1, the other axial end part of the shank part 2 has a circular truncated cone shape which is tapered in the direction the other axial end faces. A part 7 having the circular truncated cone shape (hereinafter, “circular truncated cone shape part”) is provided with the guiding protrusion 4. No screw thread is formed on the outer circumferential surface of the circular truncated cone shape part 7. Accordingly, the circular truncated cone shape part 7 does not function as a screw.

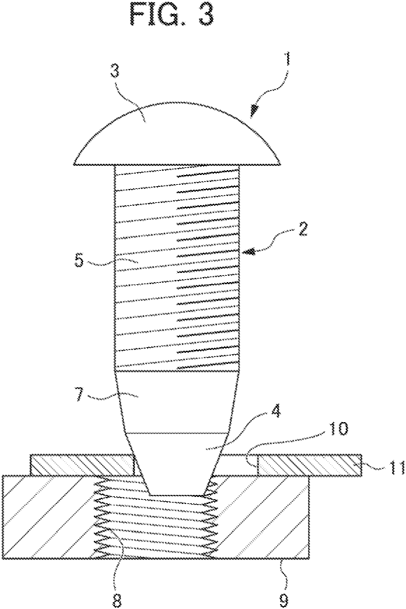

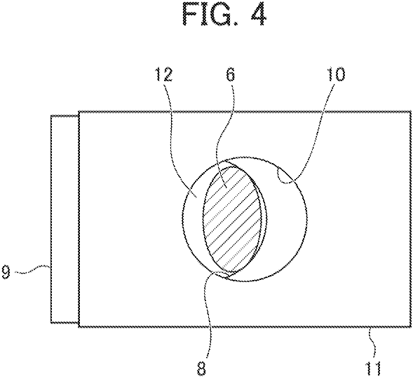

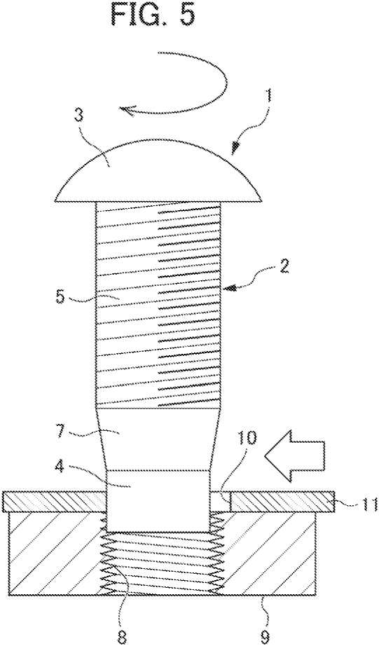

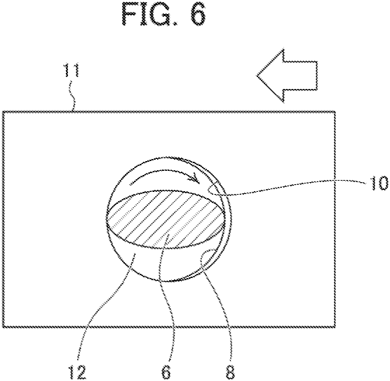

Next, an example of a screw member fastening method using the screw member 1 of the first embodiment will be described. FIG. 3 is a front view illustrating a state in which the screw member of the first embodiment is being used, partially shown in cross section. FIG. 4 is a plan view illustrating the state in which the screw member of the first embodiment is being used, while a part thereof is omitted. FIG. 5 is a front view illustrating another state in which the screw member of the first embodiment is being used, after the screw member has been turned on the axis thereof from the state shown in FIG. 3. FIG. 6 is a plan view illustrating the state in which the screw member of the first embodiment is being used while a part thereof is omitted, after the screw member has been turned on the axis thereof from the state shown in FIG. 3.

The screw member fastening method uses the screw member 1 of the first embodiment to fasten a fastening member 9 having a screw hole 8 into which the screw member 1 is to be screwed, and a fastening target 11 having a through hole 10 to be penetrated by the screw member 1. The screw member fastening method includes the following steps that are sequentially performed: a member placement step, a guiding protrusion insertion step, a guiding protrusion turning step, and a fastening step.

In the member placement step, the fastening target 11 is placed on the fastening member 9. In this step, when the fastening target 11 is placed on the fastening member 9, a part of the screw hole 8 overlaps with a part of the through hole 10. In other words, the position of the screw hole 8 is out of alignment with the position of the through hole 10.

In the guiding protrusion insertion step, the guiding protrusion 4 of the screw member 1 is inserted into the screw hole 8, after the member placement step. In this step, the guiding protrusion 4 is inserted into the screw hole 8 via the through hole 10, in such a manner that the long direction of the cross-sectional plane 6 of the tip end part of the guiding protrusion 4 extends along the long direction of an overlap part 12 where the part of the screw hole 8 overlaps with the part of the through hole 10. The guiding protrusion 4 is inserted into the screw hole 8 without allowing the screw member 1 to tilt with respect to the screw hole 8. As shown in FIG. 3, in the guiding protrusion insertion step, the shank part 2 is not yet screwed into the screw hole 8.

In the guiding protrusion turning step, the screw member 1 is turned while the guiding protrusion 4 is in the screw hole 8, after the guiding protrusion insertion step. In this step, turning the screw member 1 on the axis thereof causes the fastening target 11 to move relative to the fastening member 9 so as to make the overlap part 12 enlarge. As a result of turning the screw member 1 on the axis thereof, the guiding protrusion 4 comes into contact with the inner circumferential surface of the screw hole 8 and the inner circumferential surface of the through hole 10, whereby the fastening target 11 moves relative to the fastening member 9. Consequently, the overlap part 12 enlarges in the short direction of the cross-sectional plane 6 of the tip end part of the guiding protrusion 4 observed in the state where the guiding protrusion 4 is in the screw hole 8 (the short direction of the cross-sectional plane 6 of the tip end part of the guiding protrusion 4 in FIG. 4).

In the fastening step, the shank part 2 of the screw member 1 is screwed into the screw hole 8, after the guiding protrusion turning step. In this step, the screw member 1 is turned on the axis thereof, whereby the shank part 2 of the screw member 1 is screwed into the screw hole 8 via the through hole 10. When the shank part 2 is screwed into the screw hole 8, the misalignment between the position of the screw hole 8 and the position of the through hole 10 has substantially been eliminated by the guiding protrusion turning step.

In the case of the screw member 1 according to the first embodiment, the cross-sectional plane 6 perpendicular to the axial direction of the tip end part of the guiding protrusion 4 has the long direction and the short direction perpendicular to the long direction. Due to this feature, even when the position of the screw hole 8 is out of alignment with the position of the through hole 10, it is possible to insert the tip end part of the screw member 1 into the screw hole 8, without allowing the screw member 1 to tilt with respect to the screw hole 8. Further, subsequently turning the screw member 1 makes it possible to correct the misalignment between the position of the screw hole 8 and the position of the through hole 10. As a result, it is possible to easily realize the fastening using the screw member 1, without causing defective fastening of the screw member 1.

In the case of the screw member 1 according to the first embodiment, the cross-sectional plane 6 of the tip end part of the guiding protrusion 4 has the oval shape. This feature makes it unlikely for the screw hole 8 and the through hole 10 to be deformed when the guiding protrusion 4 comes into contact with the inner circumferential surface of the screw hole 8 or the inner circumferential surface of the through hole 10. As shown in FIG. 4, the overlap part 12 where the part of the screw hole 8 overlaps with the part of the through hole 10 has a shape close to an oval shape. Consequently, when the cross-sectional plane 6 of the tip end part of the guiding protrusion 4 has the oval shape, the guiding protrusion 4 into the screw hole 8 is easy to insert. As shown in FIG. 5, in the guiding protrusion turning step, the screw member 1 is turned while the guiding protrusion 4 is in the screw hole 8. The cross-sectional plane 6 of the tip end part of the guiding protrusion 4 having an oval shape makes it possible to reduce the torque generated when the screw member 1 is turned, thereby contributing to enhancement of workability.

In the screw member fastening method using the screw member 1 according to the first embodiment, the member placement step, the guiding protrusion insertion step, the guiding protrusion turning step, and the fastening step are performed sequentially. This feature eliminates the possibility that the screw member 1 may be screwed into the screw hole 8, while the screw member 1 is tilted with respect to the screw hole 8. According to the screw member fastening method using the screw member 1 of the first embodiment, after the screw member 1 is turned in order to correct the misalignment between the position of the screw hole 8 and the position of the through hole 10, the screw member 1 is turned in order to screw the screw member 1 into the screw hole 8. Thus, the misalignment between the position of the screw hole 8 and the position of the through hole 10 is corrected by way of the operation for screwing the screw member 1 into the screw hole 8, thereby making it possible to further facilitate the fastening using the screw member 1.

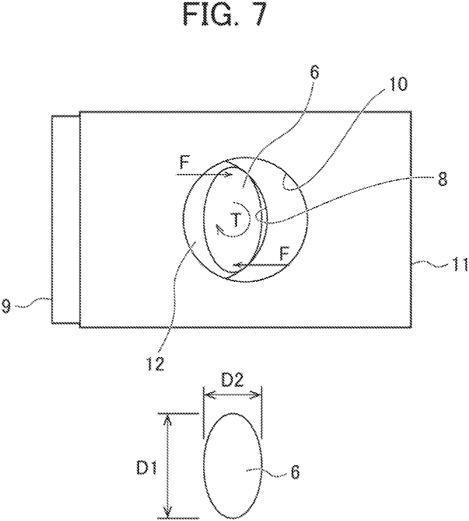

FIG. 7 is a drawing for explaining a force that is applied when the screw member according to the first embodiment is turned on the axis thereof. As shown in the drawing, a force F acting to correct the misalignment between the position of the screw hole 8 and the position of the through hole 10 satisfies F > T/(D½). Here, T represents a torque, and D1 represents the length, in the long direction, of the cross-sectional plane 6 of the tip end part of the guiding protrusion 4. For example, when an M6 bolt (D1 = 4 mm) is turned with a torque of 10 Nm, the force F satisfies F > 10 × 1000/(4/2) = 5000 N. As can be seen, the screw member 1 according to the first embodiment facilitates use of large torque.

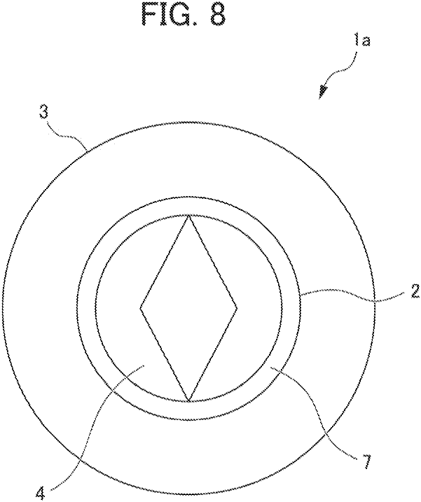

Next, a screw member 1a according to a second embodiment of the present invention will be described. FIG. 8 is a bottom view illustrating the screw member according to the second embodiment. In the second embodiment, characteristic parts thereof will be described, and a description of the components that have been described in the first embodiment will be omitted.

In the second embodiment, the configuration of the guiding protrusion 4 is different from that in the first embodiment. Specifically, in the screw member 1a according to the second embodiment, a cross-sectional plane 6 of a tip end part of the guiding protrusion 4 is perpendicular to the axial direct and has a rhomboidal shape. In this case, similarly to the first embodiment, the cross-sectional plane 6 of the tip end part of the guiding protrusion 4 has a long direction and a short direction perpendicular to the long direction.

In the case of the screw member 1a according to the second embodiment, the cross-sectional plane 6 of the tip end part of the guiding protrusion 4 has the rhomboidal shape. Thus, the tip end of the screw member 1a is pointed, thereby making it possible, even when the overlap part 12 where a part of a screw hole 8 overlaps with a part of a through hole 10 is smaller, to insert the guiding protrusion 4 into the overlap part 12. The rhomboidally shaped cross-sectional plane 6 of the tip end part of the guiding protrusion 4 can be made to have a smaller area than the cross-sectional plane 6 having an oval shape. Thus, at the time of insertion into the overlap part 12, the guiding protrusion 4 is less likely to come into contact with the fastening member 9 or the fastening target 11, thereby making it possible to further enhance workability.

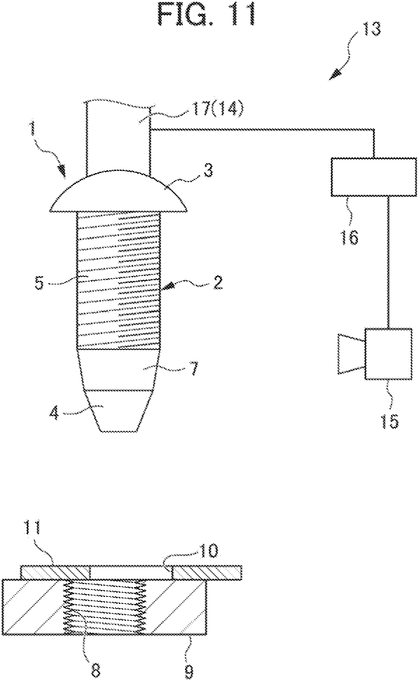

Next, an example of a screw member fastening device 13 using the screw member 1 according to the first embodiment will be described. FIG. 11 is a schematic diagram illustrating a configuration of the screw member fastening device according to an embodiment of the present invention. The screw member fastening device 13 fastens, by using the screw member 1 according to the first embodiment, the fastening member 9 having the screw hole 8 into which the screw member 1 is to be screwed and the fastening target 11 having the through hole 10 to be penetrated by the screw member 1. The screw member fastening device 13 includes a mover 14, an imager 15, and a controller 16.

The mover 14 is a means which has a holding part 17 to hold the screw member 1 and which is for moving the holding part 17. The mover 14 may be a robot, for example. The robot 14 has a well-known configuration and, for example, has an arm that includes the holding part 17 as a hand thereof and that is configured to move the holding part 17. The arm has a plurality of joints, while each of the joints is provided with a motor. By driving the motors provided for the joints, the robot 14 can move the holding part 17. Each of the joints of the robot 14 is provided with an encoder. Each encoder is capable of detecting a rotation position of an associated one of the motors provided at the joints, and the position of the holding part 17 can be calculated on the basis of results of the detection.

The imager 15 is a means for obtaining an image by imaging the screw member 1 held by the holding part 17 and imaging the overlap part 12. The imager 15 may be a camera, for example. In the illustrated example, an image of the screw member 1 held by the holding part 17 and the overlap part 12 are imaged by the single camera 15. Images of the screw member 1 held by the holding part 17 and the overlap part 12 may be captured by two or more cameras. The screw member 1 held by the holding part 17 and the overlap part 12 may each be imaged by one camera or may each be imaged by a plurality of cameras.

The controller 16 controls the mover 14 on the basis of the image obtained by the imager 15. The controller 16 may be a controller for the robot 14, for example. For example, on the basis of the image obtained by the imager 15, the controller 16 detects the position of the screw member 1 held by the holding part 17 and the position of the overlap part 12. For this purpose, the controller 16 is connected to the camera 15. On the basis of the difference between the position of the screw member 1 held by the holding part 17 and the position of the overlap part 12, the controller 16 controls the mover 14. In other words, the controller 16 controls the mover 14, so that the screw member 1 held by the holding part 17 reaches the overlap part 12. It should be noted that the control exercised by the controller 16 over the mover 14 is not limited to the example described above. It is possible to employ well-known feedback control.

The screw member fastening device 13 fastens the fastening member 9 and the fastening target 11 in the following manner. The fastening target 11 is placed on the fastening member 9, as shown in FIG. 3, so that a part of the screw hole 8 overlaps with a part of the through hole 10. In this state, the guiding protrusion 4 is inserted into the screw hole 8 via the through hole 10, in such a manner that the long direction of the cross-sectional plane 6 of the tip end part of the guiding protrusion 4 extends along the long direction of the overlap part 12 where the part of the screw hole 8 overlaps with the part of the through hole 10. At this time, the controller 16 controls the mover 14 as described above, whereby the guiding protrusion 4 of the screw member 1 held by the holding part 17 is inserted into the screw hole 8.

Further, as shown in FIG. 5 and FIG. 6, in the state in which the guiding protrusion 4 is in the screw hole 8, the screw member 1 is turned on the axis thereof, and the fastening target 11 is moved relative to the fastening member 9 so as to enlarge the overlap part 12. The screw member 1 held by the holding part 17 is turned on the axis thereof by driving a motor (not shown) provided for the mover 14. After the fastening target 11 is moved relative to the fastening member 9, the shank part 2 of the screw member 1 is screwed into the screw hole 8 via the through hole 10, by further turning the screw member 1 on the axis thereof. Screwing the shank part 2 into the screw hole 8 results in that the fastening member 9 and the fastening target 11 are fastened together.

The present invention is not limited to the embodiments described above. As long as the object of the present invention is achieved, modifications and improvements are encompassed in the scope of the present invention.

For example, in the embodiments above, the cross-sectional plane 6 of the tip end part of the guiding protrusion 4 has an oval shape or a rhomboidal shape. However, these shapes are non-limiting examples. The cross-sectional plane 6 may have a triangular or rectangular shape.

EXPLANATION OF REFERENCE NUMERALS

| | |
|---|---|
| 1: | SCREW MEMBER |
| 2: | SHANK PART |
| 3: | HEAD PART |
| 4: | GUIDING PROTRUSION |
| 5: | SCREW THREAD |
| 8: | SCREW HOLE |
| 9: | FASTENING MEMBER |
| 10: | THROUGH HOLE |
| 11: | FASTENING TARGET |
| 12: | OVERLAP PART |
| 13: | SCREW MEMBER FASTENING DEVICE |
| 14: | MOVER |
| 15: | IMAGER |
| 16: | CONTROLLER |
| 17: | HOLDING PART |

What is claimed is:

1. A screw member comprising:
a shank part having a circular columnar shape and having a screw thread formed on an outer circumferential surface thereof;
a head part provided on one axial end part of the shank part; and
a guiding protrusion protruding from an other axial end part of the shank part in a direction in which the other axial end part faces, wherein
a tip end part of the guiding protrusion has a long direction and a short direction perpendicular to the long direction.

2. The screw member according to claim 1, wherein the tip end part of the guiding protrusion has an oval shape.

3. The screw member according to claim 1, wherein the tip end part of the guiding protrusion has a rhomboidal shape.

4. A screw member fastening method that uses the screw member according to claim 1 for fastening a fastening member having a screw hole into which the screw member is to be screwed and a fastening target having a through hole to be penetrated by the screw member, the screw member fastening method comprising:
a member placement step of placing the fastening target on the fastening member such that a part of the screw hole overlaps with a part of the through hole;
a guiding protrusion insertion step of inserting the guiding protrusion into the screw hole via the through hole in such a manner that the long direction of the tip end part of the guiding protrusion extends along a long direction of an overlap part where the part of the screw hole overlaps with the part of the through hole;
a guiding protrusion turning step of turning the screw member on an axis thereof so as to move the fastening target relative to the fastening member, thereby enlarging the overlap part; and
a fastening step of screwing the shank part of the screw member into the screw hole via the through hole by turning the screw member on the axis thereof.

5. A screw member fastening device for fastening, by using the screw member according to claim 1, a fastening member having a screw hole into which the screw member is to be screwed and a fastening target having a through hole to be penetrated by the screw member,
the screw member fastening device being configured such that:
in a state in which the fastening target is placed on the fastening member while a part of the screw hole overlaps with a part of the through hole, the screw member fastening device inserts the guiding protrusion into the screw hole via the through hole in such a manner that the long direction of the tip end part of the guiding protrusion extends along a long direction of an overlap part where the part of the screw hole overlaps with the part of the through hole; the screw member fastening device subsequently turns the screw member on the axis thereof so as to move the fastening target relative to the fastening member, thereby enlarging the overlap part; and the screw member fastening device further turns the screw member on the axis thereof so as to screw the shank part of the screw member into the screw hole via the through hole, the screw member fastening device comprising:
a mover having a holding part that is configured to hold the screw member, and configured to move the holding part;
an imager configured to obtain an image by imaging the screw member held by the holding part and imaging the overlap part; and
a controller configured to control the mover based on the image obtained by the imager.
